(19) United States
(12) Patent Application Publication
(10) Pub. No.: US 2024/0020531 A1
(43) Pub. Date: Jan. 18, 2024

(54) System and Method for Transforming a Trained Artificial Intelligence Model Into a Trustworthy Artificial Intelligence Model

(71) Applicant: Siemens Aktiengesellschaft, Muenchen (DE)

(72) Inventors: Erik SCEPANSKI, Nürnberg (DE); Florian BÜTTNER, München (DE); Christian SEITZ, Nürnberg (DE); David AMSLINGER, Nürnberg (DE); Giuliana BARRIOS DELL'OLIO, Gröbenzell (DE)

(21) Appl. No.: 18/036,954

(22) PCT Filed: Oct. 21, 2021
(86) PCT No.: PCT/EP2021/079215

§ 371 Date: May 15, 2023

(30) Foreign Application Priority Data
Nov. 17, 2020 (EP) 20208211

(51) Int. Cl. G06N 3/08

(52) U.S. Cl. CPC G06N 3/08

(57) ABSTRACT

A computer-implemented method and system for transforming a trained artificial intelligence (AI) model into a trustworthy artificial intelligence model, wherein the trained AI model is provided via a user interface of a webservice platform, a validation data set based on training data of the trained artificial intelligence model is provided, generic samples are generated by a computing component of the webservice platform based on the validation data set, the trained artificial intelligence model is transformed by optimizing a calibration based on the generic samples, where the transformation of the artificial intelligence model is performed by a computing component of the web service platform, and the input, i.e. the trained artificial intelligence model and a validation data set, is provided therefor to the computing component via a user interface of the web service platform.

### CROSS-REFERENCE TO RELATED APPLICATIONS

This is a U.S. national stage of application No. PCT/EP2021/079215 filed 21 Oct. 2021. Priority is claimed on European Application No. 20208211.1 filed 17 Nov. 2020, the content of which is incorporated herein by reference in its entirety.

### BACKGROUND OF THE INVENTION

### 1. Field of the Invention

The present invention relates to a computer-implemented method and a system for transforming a trained artificial intelligence model into a trustworthy artificial intelligence model.

### 2. Description of the Related Art

To facilitate a wide-spread acceptance of artificial intelligence (AI) systems guiding decision making in real-world applications, trustworthiness of deployed models is key. Not only in safety-critical applications, such as autonomous driving or Computer-aided Diagnosis Systems (CDS), but also in dynamic open world systems in industry it is crucial for predictive models to be uncertainty-aware and yield well-calibrated (and thus trustworthy) predictions for both in-domain samples (“known unknowns”) as well as out-of-domain samples (“unknown unknowns”). In particular, in industrial and IoT settings, deployed models may encounter erroneous and inconsistent inputs far away from the input domain throughout the life-cycle. In addition, the distribution of the input data may gradually move away from the distribution of the training data, e.g., due to wear and tear of the assets, maintenance procedures or change in usage patterns. The importance of technical robustness and safety in such settings is also highlighted by the recently published “Ethics guidelines for trustworthy AI” by the European Commission, requiring for trustworthy AI to be lawful, ethical and robust—technically and taking into account its social environment.

In conventional approaches, for each new asset or new environment a new model is trained. However, this is costly, because production must be stopped during the acquisition of new training data, labeling is expensive and also the procedure of training models comes at a high cost of human and IT resources.

Moreover, statistical methods to detect domain drift based on the input data are known. These methods are highly specific to individual data sets. As known methods cannot determine the effect of potential data drifts on the accuracy, a retraining of the model as well as a data generation process is necessary.

Common approaches to account for predictive uncertainty include post-processing steps for trained neural networks (NN) and training probabilistic models, including Bayesian and non-Bayesian approaches. However, training such intrinsically uncertainty aware models from scratch comes at a high computational the cost. Moreover, highly specialized knowledge is needed to implement and train such models.

However, while an increasing predictive entropy for an increasingly strong domain drift or perturbations can be an indicator for uncertainty-awareness, simply high predictive entropy is not sufficient for trustworthy predictions. For example, if the entropy is too high, the model will yield under-confident predictions and similarly, if the entropy is too low, predictions will be over-confident.

### SUMMARY OF THE INVENTION

Considering the described drawbacks in the state-of-the-art, it is therefore an objective to provide a method and corresponding computer program product and apparatus for providing a trustworthy artificial intelligence model.

These and other objects and advantages are achieved in accordance with the invention by a computer-implemented method for transforming a trained artificial intelligence model into a trustworthy artificial intelligence model, where the method includes providing the trained artificial intelligence model via a user interface of a webservice platform, providing a validation data set that is based on training data of the trained artificial intelligence model, generating generic samples by a computing component of the webservice platform based on the validation data set, and transforming the trained artificial intelligence model by optimizing a calibration based on the generic samples.

A conventional trained artificial intelligence (AI) model is provided as an input for the inventive method. Any trained AI model might be used and there is no specific requirement on the training level or on a maturity level or on the accuracy of the model. The higher the quality of the trained model, the easier and faster the method can be performed. Moreover, the provided trustworthy artificial intelligence model has a corresponding better quality.

As AI-models, for example, AI based classifiers are used. For example, machine learning models might be used, e.g., deep learning-based models, neural networks, logistic regression models, random forest models, support vector machine models or tree-based models with decision trees as a basis might be used according to the application the AI-model is to be used for.

Any set of training data, which has been used to train the model or which has been generated or were collected in order to train the model, can be used to extract a validation data set. Thereby, the validation data set can be the training data or a sub-set or a part of the training data or can be derived from the training data. The validation data set particularly comprises a set of labelled sample pairs, also referred to as samples.

The transformation of the AI model is performed by a computing component of the web service platform. The input, i.e., the trained artificial intelligence model, as well as a validation data set, is provided therefor to the computing component via a user interface of the web service platform. Such a user interface can be implemented by any applicable frontend, for example, by a web app.

The validation data set can be provided via the same user interface of the web service platform. Moreover, the training data set can be provided by the user interface and a validation data set is derived from the training data by the computing component.

Based on the validation data set, generic samples are generated. Those generic samples reflect a domain drift, whereby preferably a plurality of generic samples is generated, reflecting different levels or different degrees of domain drift. In other words, a plurality of generic samples is generated representing different strengths of perturbations. Those perturbations can reflect predictable or foreseeable or likely influences on the expected in-domain samples or they can alternatively reflect purely random modifications of the samples or they might further alternative reflect specific intended modifications in the sense of generation of adversarial samples. Thereby, a spectrum ranging from in-domain samples to out-of-domain samples is preferably generated. Samples in more detail are sample pairs. A pair comprises an input object, in particular a vector or matrix, and a desired output value or label, also called the supervisory signal. According to this, the model input can be equally referred to as input object and the model output can be equally referred to as output value or label. The input of a sample from the validation data set is adapted to reflect the domain drift.

Based on the generated generic examples, the calibration is optimized. This can be achieved, e.g., within a step of adapting the AI model, especially weights of a neural network, or within the step of postprocessing outputs of an AI model.

Optimizing the calibration, based on the generic samples, results in an AI model that ensures interpretability for the predicted probabilities for the different classes of a classifier. Optimizing the calibration is in contrast to conventional approaches, where the accuracy is optimized. Moreover, in contrast to conventional approaches, not only adversarial samples in terms of attacks are used, but samples underlying a domain drift, in particular a domain drift with varying perturbation level. Combining the generation of generic samples with an optimization of the calibration based on those generic samples is the differentiator over conventional approaches and leads to the advantages described herein.

The calibration is optimized, so that “confidence scores”, meaning probabilities for a specific class, match an accuracy. Therefore, a confidence derived from the trustworthy AI model corresponds to a certain degree of certainty.

As the calibration is performed with the help of the generated generic samples, the confidence matches the accuracy for all levels of perturbations that are reflected in the generic samples.

The step of optimizing the calibration therefore links confidence-scores or probabilities with accuracy over the whole range of generic samples. The calibrated trustworthy AI model predicts well-calibrated uncertainties, with the confidence, e.g., the entropy, matching the actual predictive power of the model.

The method enables the transformation of an AI model into a trustworthy AI model by using an uncertainty aware calibration optimization method. The trustworthy AI model determines trustworthy probabilities for both in-domain samples as well as out-of-domain samples.

The trustworthy AI model in embodiments is an adapted model based on the AI model and, e.g., adapted in terms of weights of knots within a neural network or in other embodiments is an extended AI model comprising a post-processing algorithm.

In an advantageous manner, overconfident predictions are avoided using the trustworthy AI model obtained with the inventive method. Using the trustworthy AI model, a user knows that when a confidence decreases the accuracy also decreases in a coordinated manner, so that the user can make an informed decision on when to re-train or replace an AI model. Moreover, an instant feedback on the prediction quality is received by analyzing the accuracy of the trustworthy AI model for given inputs in a real-world scenario. In an advantageous manner, the user instantly knows, whether an AI model can be used, for example, in a new context, such as a new factory, or whether the AI model needs to be re-trained, potentially saving substantially efforts for unnecessary data collection and model training.

A method is proposed to automatically transform conventional neural networks. For the proposed method, there is no expert scientist necessary to provide custom implementations of modified neural networks. Lay users are enabled to integrate trustworthiness in any machine learning development pipeline. Trustworthy AI is therefore made accessible to a large user base of applied practitioners without expert knowledge.

With the transformation method that optimizes the calibration, the architecture or structure of the AI model is not affected, so that the trustworthy AI model can be deployed directly for the intended use case or application without a further mandatory validation phase. This is the case in particular for transformation methods based on a re-training of the AI model or a postprocessing of the output of the AI model. These characteristics of the method enable the usage as a webservice, so that starting from a pre-trained AI-model, the transformation is offered as a service by a cloud platform in particular.

In accordance with an embodiment, by optimizing the calibration, an uncertainty-awareness is represented in a confidence-level for any of the generic samples. In cases that the AI model realizes a certain level of uncertainty, a predicted classification is equally distributed among the given classes of the classifier. This, for example, leads to a low and equally distributed confidence score. This is achieved, for example, by assigning a high entropy in case of an uncertain classification result and, for example, via adapting the objective function of the AI model or postprocessing outputs of the AI model.

Depending on the specific method used for transforming the trained AI model, a re-training of the AI model or a post-processing of outputs of AI model or any further suitable transforming methods are performed. For retraining methods, preferably only a small validation data set is necessary if the trained AI model is a substantially mature trained AI model. In cases of only roughly pre-trained AI models, a retraining based on a more comprehensive validation data set is preferably performed. For postprocessing methods, there is no influence on the AI model in terms of structure or architecture, in particular no weights are adapted, so that the trained AI model is preferably provided on a refined level, so that the calibrated trustworthy AI model can be applied after the transformation directly.

In accordance with an embodiment, the validation data set is modified by a domain-drift to generate the generic samples. More specifically, the validation data set is modified by an algorithm representing a domain drift. For example, samples of the validation data set can be modified by adding a noise signal. Preferably, the validation data set is modified in a way, that typical drift an industrial environment is represented, for example due to contaminated camera lenses, vibrations, etc.

In accordance with an embodiment, the validation data set is modified according to perturbation strengths to generate the generic samples. With this modification, different levels of perturbations are achieved. Preferably, generic samples are generated that reflect perturbations ranging from typical domain drift within an industrial environment to modifications that reflect truly out of domain samples.

In accordance with an embodiment, transforming comprises applying an entropy-based loss term that encourages uncertainty-awareness. Such an entropy-based loss term is preferably used for a neural network based AI model. Preferably, an entropy loss term is provided in addition to a convenient loss term, e.g., a cross-entropy loss term. With these combined loss terms, the neural network is encouraged towards a uniformly distributed softmax output in cases of uncertainty.

In accordance with an embodiment, transforming further comprises performing a re-training of the AI-model with applying a calibration loss term. By combining an entropy-based loss term with a calibration loss term, the technical robustness of the model is increased for inputs that are close or similar to the validation data or training data.

In accordance with an embodiment, the following steps are performed:
computing a categorical cross-entropy loss for the validation data set based on current outputs of the trained AI model and corresponding ground truth data of the validation data set;
computing a predictive entropy loss by removing non-misleading evidence from the current outputs and distributing the remaining current outputs over a predetermined number of classes;
computing a combined loss by adding to the categorical cross-entropy loss the predictive entropy loss weighted with a predetermined first loss factor λs, where 0 <=λs<=1;
checking whether the re-training converged to a predefined lower limit for a convergence rate;
updating weights of the AI model based on the combined loss and a predetermined training rate η, where 0<η<=1, in case the re-training did not converge; and
stopping the re-training of the AI model in case the re-training converged.

Encouraging a high entropy with the proposed combined loss term encourages the model towards a uniformly distributed probability distribution, for example, the output of the softmax function, in cases of uncertainty.

In accordance with an embodiment, the following further steps are performed:
generating perturbed outputs of the for the generic samples by forward propagating the generic input data of the generic samples in the AI model;
computing a calibration loss as the Euclidian norm of an expected calibration error, which takes a weighted average over the perturbed outputs grouped in a predefined number of equally spaced bins each having an associated average confidence and accuracy;
checking whether the re-training converged to a predefined lower limit for a convergence rate;
first time updating weights of the AI model based on the combined loss and a predetermined training rate η, where 0<η<=1, in case the training did not converge;
second time updating the weights of the AI model based on the calibration loss weighted with a predetermined second loss factor λ_{adv}, where 0<=λ_{adv}<=1, and the predetermined training rate η, in case the training did not converge; and
stopping the training of the AI model in case the training converged.

With the proposed calibration loss term, the technical robustness of the AI model increases for inputs built of the validation data set or training samples of the validation data set and underlying a variety of perturbation levels.

In accordance with an embodiment, the artificial intelligence model is a neural network.

An embodiment with combined loss term and calibration loss term is described in more detail. A computer-implemented method of re-training a neural network to transform a trained neural network into a trustworthy neural network comprises the steps of receiving a validation data set T of validation input data X=(X₁, . . . , Xₙ) and corresponding ground truth data Y=(Y₁, . . . , Yₙ) for a predetermined number C of classes. Thereby, n is greater than one (n>1) and C is greater than or equal to one (C>=1). The step of re-training the neural network comprises the iterative training steps of selecting a validation sub-set, generating current outputs, computing a categorical cross-entropy loss, computing a predictive entropy loss, computing a combined loss, providing a perturbation level, generating a generic sample set, generating perturbed outputs, computing a calibration loss, checking whether the training converged, first time updating weights, second time updating the weights and stopping the training. In the training step of selecting a validation sub-set, a validation sub-set B of validation input data X_{B} and corresponding ground truth data Y_{B} is selected from the validation set T. Thereby, the cardinal number of the validation sub-set is greater than zero and smaller than the cardinal number of the validation set (0<|B|<|T|).

In the re-training step of generating current outputs, current outputs of the neural network for the sub-set B are generated by forward propagating the validation input data X_{B} of the training sub-set B in the neural network. In the re-training step of computing a categorical cross-entropy loss, a categorical cross-entropy loss L_{CCE} for the sub-set B is computed based on the current outputs and the corresponding ground truth data Y_{B} of the training sub-set B. In the re-training step of computing a predictive entropy loss, a predictive entropy loss L_{S} is computed by removing non-misleading evidence from the current outputs and distributing the remaining current outputs over the predetermined number C of classes. In the re-training step of computing a combined loss, a combined loss L is computed by adding to the categorical cross-entropy loss L_{CCE} the predictive entropy loss L_{S} weighted with a predetermined first loss factor λ_{S}. Thereby, the first loss factor λ_{S} is greater than or equal to zero and smaller than or equal to 1 (0<=λ_{S}<=1).

In the re-training step of providing or sampling a perturbation level, a perturbation level ε_{B} is randomly sampled with a value from 0 to 1. In the re-training step of generating an generic sample set, a generic sample set B_{g} of generic input data X_{g} is generated by applying a perturbation randomly selected from a predefined set of perturbations and weighted with the perturbation level ε_{B} to the validation input data X_{B} of the validation sub-set B. Thereby the cardinal number of the generic input data is equal to the cardinal number of the validation input data of the validation sub-set (|X_{adv}|=|X_{B}|) In the re-training step of generating perturbed outputs, perturbed outputs of the neural network for the generic sample set B_{g} are generated by forward propagating the generic input data X_{g} of the generic sample set B_{g} in the neural network in the training step of computing a calibration loss, a calibration loss L_{g} is computed as the Euclidian norm (L₂ norm) of an expected calibration error ECE. The expected calibration error ECE takes a weighted average over the perturbed outputs grouped in a predefined number M of equally spaced bins each having an associated average confidence and accuracy. Thereby the predefined number M is greater than one (M>1).

In the re-training step of checking whether the training converged, a check is performed to determine whether the training converged to a predefined lower limit for a convergence rate. In the step of first time updating weights, weights of the neural network are updated first time based on based on the combined loss L and a predetermined training rate η, where the predetermined training rate η is greater than zero and smaller than or equal to one (0<η<=1), in case the training did not converge.

In the step of second time updating weights, weights of the neural network are updated a second time based on the calibration loss L_{g} weighted with a predetermined second loss factor λ_{g}, where the predetermined second loss factor λ_{g} is greater than or equal to zero and smaller than or equal to one (0<=λ_{adv}=1), and the predetermined training rate η, in case the training did not converge. In the step of stopping the training, the training of the neural network is stopped in case the training converged.

The received validation data set T also comprises the corresponding ground truth data Y. The ground truth data Y comprises multiple samples of ground truth data Y₁ to Yₙ that corresponds to the respective samples of the validation input data X₁ to Xₙ. The corresponding ground truth data gives the information that is to be deduced by the neural network.

Each pair of sample of validation input data and corresponding sample of ground truth data X₁, Y₁ to Xₙ, Yₙ, belongs to one of the classes.

For example, the samples of validation input data X₁ to Xₙ may be different images showing handwritten numbers and the corresponding samples of ground truth data Y₁ to Yₙ may be the respective number that is to be deduced by the neural network. The classes may be C=10 classes where each class represents one number (0 to 9). Here the C=10 classes could be one-hot encoded in the following way:
0 corresponds to 1 0 0 0 0 0 0 0 0 0
1 corresponds to 0 1 0 0 0 0 0 0 0 0
2 corresponds to 0 0 1 0 0 0 0 0 0 0
3 corresponds to 0 0 0 1 0 0 0 0 0 0
4 corresponds to 0 0 0 0 1 0 0 0 0 0
5 corresponds to 0 0 0 0 0 1 0 0 0 0
6 corresponds to 0 0 0 0 0 0 1 0 0 0
7 corresponds to 0 0 0 0 0 0 0 1 0 0
8 corresponds to 0 0 0 0 0 0 0 0 1 0
9 corresponds to 0 0 0 0 0 0 0 0 0 1

As another example, the samples of validation input data X₁ to Xₙ may be different medical image data such as Magnetic Resonance images, and/or Computer Tomography images, Sonography images, and the corresponding samples of ground truth data Y₁ to Yₙ may be respective maps where each pixel or voxel of the medical image data is assigned a different type of tissue or organ that is to be deduced by the NN. The classes may be C=3 classes where each class represents one type of tissue. Here, the C=3 classes could be one-hot encoded in the following way:
normal tissue corresponds to 1 0 0
tumorous tissue corresponds to 0 1 0
fibrous tissue corresponds to 0 0 1

Alternatively, the classes may be C=4 classes where each class represents one type of organ. Here, the C=4 classes could be one-hot encoded in in accordance with the following:
lung tissue corresponds to 1 0 0 0
heart tissue corresponds to 0 1 0 0
bone corresponds to 0 0 1 0
other tissue corresponds to 0 0 0 1

As another example, the samples of validation input data X₁ to Xₙ may be data of varying courses of different physical quantities such as force, temperature, or speed, and the corresponding samples of ground truth data Y₁ to Yₙ may be respective state of a machine that is to be deduced by the neural network. The classes may be C=3 classes where each class represents one state of the machine. Here, the C=3 classes could be one-hot encoded in accordance with the following:
normal operation corresponds to 1 0 0
start-up phase corresponds to 0 1 0
failure corresponds to 0 0 1

As another example, the samples of validation input data X₁ to Xₙ may be texts regarding different topics such as politics, sports, economics, or science, and the corresponding samples of ground truth data Y₁ to Yₙ may be the respective topic that is to be deduced by the neural network. The classes may be C=4 classes where each class represents one topic. Here, the C=4 classes could be one-hot encoded in accordance with the:
politics corresponds to 1 0 0 0
sports corresponds to 0 1 0 0
economics corresponds to 0 0 1 0
science corresponds to 1 0 0 0

In accordance with an embodiment, transforming comprises post-processing an output of the AI model. Advantageously, when performing a post-processing, the AI model does not have to be retrained in order to be transformed into the trustworthy AI model. Therefore, the AI model does not have to be provided detailed architectural information. That means that even black box classifiers can be transformed with the proposed method. The step of post-processing itself can be interpreted as a step of learning a post-processing-model and is not to be mixed with the training of the AI model provided by the user of the webservice platform.

The post-processing can be parametric or non-parametric. An example of a parametric post-processing method is Platt's method that applies a sigmoidal transformation that maps the output of a predictive model to a calibrated probability output. The parameters of the sigmoidal transformation function are learned using a maximum likelihood estimation framework. The most common non-parametric methods are based either on binning (Zadrozny and Elkan 2001) or isotonic regression (Zadrozny and Elkan 2002). For example, histogram binning is used introduced by Naeini, M. P., Cooper, G. F., & Hauskrecht, M. (2015, January) for obtaining well calibrated probabilities using bayesian binning.

For the post-processing, again generic samples are generated and fed into the trained AI model. The output of the trained AI model impinged with the generic samples is then calibrated.

In an embodiment, a set of samples covering the entire spectrum from in-domain samples to truly out-of-domain samples in a continuous and representative manner is generated. For example, the fast gradient sign method is applied to the validation data set to generate generic samples, with varying perturbation strength. More specifically, for each sample in the validation set, the derivative of the loss with respect to each input dimension is computed and the sign of this gradient is recorded. If the gradient cannot be computed analytically, e.g., for decision trees, a 0th-order approximation is performed, computing the gradient using finite differences. Noise ε is then added to each input dimension in the direction of its gradient.

Preferably, for each sample, a noise level is picked at random, such that the generic validation set comprises representative samples from the entire spectrum of domain drift. For image data affine image transformations are applied, e.g., rotation, or translation, and image corruptions, such as blur, and/or speckle noise.

In accordance with an embodiment, during the step of post-processing, parameters of a monotonic function used to transform unnormalized logits are determined by optimizing a calibration metric based on the generic samples. For example, a strictly monotonic function, in particular a piecewise temperature scaling function or a platt scaling function or other related parameterizations of a monotonic function, is used to transform unnormalized logits of a classifier into post-processed logits of the classifier. The parameters of the function, e.g., the temperatures, are then determined by optimizing a calibration metric based on the generic samples. Such calibration metrics are, for example, the log likelihood, the Brier score, Nelder Mead or the expected calibration error. Performing, e.g., the temperature scaling, i.e., learning the temperature, based on the generic samples and not based on the validation data set (or training data set) results in a well-calibrated AI model, extended in order to comprise a post-processing step, under domain shift.

Another advantage is that the inventive method has no negative effect on the accuracy. The inventive method ensures that the classifier is well calibrated not only for in-domain predictions but yields well calibrated predictions also under domain drift.

In accordance with the method, the artificial intelligence model is a classifier, in particular one of a deep neural network, gradient boosted decision tree, xgboost, support vector machine, random forest and neural network.

In accordance with an embodiment, the validation data set is a sub-set of the training data of the trained artificial intelligence model. Preferably, a user only has to provide this sub-set of the training data and does not have to provide an entire training data set.

In accordance with an embodiment, the validation data set is generated by modifying the training data of the trained artificial intelligence model. The method step of modifying the training data to generate the validation data that can be part of method steps performed by the computing unit of the web service platform or can be performed in advance, so that a user only provides the validation data set via the user interface.

In accordance with an embodiment, the transformed artificial intelligence model is provided via the user interface of the webservice platform, in particular as a downloadable file. In an advantageous manner, the user inputs a not necessarily trustworthy AI model and receives a transformed trustworthy AI model.

The objects and advantages in accordance with the invention moreover are achieved by a computer program product comprising instructions which, when executed by a computing component, cause the computing component to carry out the method according to one of the preceding claims. The computing component for example is a processor and for example is connectable to a human machine interface. The computer program product may be formed as a function, as a routine, as a program code or as an executable object, in particular stored on a storage device.

The objects and advantages in accordance with the invention moreover are also achieved by a system for transforming a trained artificial intelligence model into a trustworthy artificial intelligence model. The system includes a user interface component to enable provision of the trained artificial intelligence model, a memory storing the trained artificial intelligence model and user assignment information, a computing component for generating generic samples based on a validation data set, where the validation data set is determined based on training data of the trained artificial intelligence model, and for transforming the trained artificial intelligence model by optimizing a calibration based on the generic samples.

For example, the computing component may comprise a central processing unit (CPU) and a memory operatively connected to the CPU.

Advantageously, the system enables lay users to transform their pre-trained AI model into a trustworthy AI model within a detachable step, including the option to use the system anytime, for example, flexibly after a retraining phase of the trust with the calibrated AI model, which has, for example, become necessary due to changed applications or scenarios the AI model is used for.

In accordance with an embodiment, the user interface of the system is accessible via a web service. This enables the user to flexibly provide the AI model and corresponding training data or validation data. The user has a transparent overview of the extent to which data and information about the AI model and corresponding data is provided.

In accordance with an embodiment, the memory and the computing component are implemented on a cloud platform. This enables a flexible adaption to the extent the web service is requested, particularly in terms of computing power.

Moreover, customer specific requirements in terms of server locations can be flexibly handled with the usage of a cloud computing platform.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the following different aspects of the present invention are described in more detail with reference to the accompanying drawings, in which:

FIG. 1 is a schematic representation of a system in accordance with a first embodiment;

FIG. 2 is a schematic flow chart diagram of a method corresponding to a second embodiment;

FIG. 3 is a schematic diagram of an output of an AI model in accordance with the prior art;

FIG. 4 is a schematic diagram of an output of a trustworthy AI model in accordance with a third embodiment.

### DETAILED DESCRIPTION OF THE EXEMPLARY EMBODIMENTS

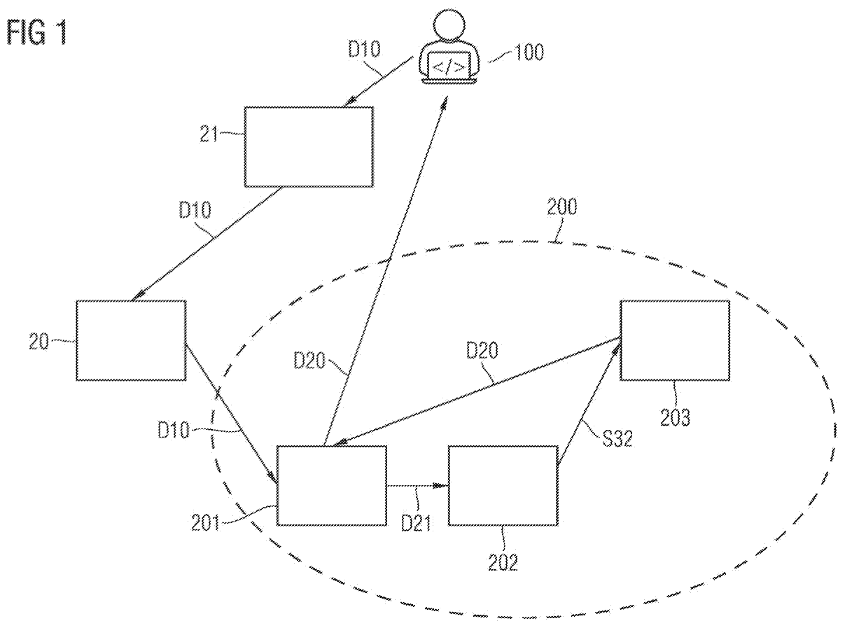

The first embodiment refers to the web service details of the inventive method. A transformation method for a trained AI model is described as part of a web service, which is accessible via a webpage. The method is illustrated via FIG. 1, which is described in more detail in the following.

A user 100, for example, accesses a webpage. The front end 20 of the webpage is, for example, realized via a web app, e.g., Elastic Beanstalk, which fetches an AWS EC2 instantiation. The web app askes the user 100 to upload a trained neural network, for example, with weights exported in a pre-specified format, e.g., hdf5. In addition, the web app askes for a representative validation data set to be provided. These user data D10 is provided by the user 100 via the user interface and front end 20, which forwards it to a cloud platform 200.

In accordance with the first embodiment, there is an additional authentication step realized with an authentication infrastructure 21, so that the user 100 is reliably identified and authenticated. For example, an e-mail address with password is used to register before the user 100 can upload the data. The user data D10 is therefore enhanced with user authentication information.

Within the cloud platform 200, a memory 201, e.g., a memory provided by AWS S3, a web-based Cloud Storage Service, saves the uploaded user data D10. An event within the AWS S3, which indicates the request for a transformation, is sent as notification D21 to a so-called Lambda function as trigger 202 for the actual transformation method.

The Lambda function is configured so that it calls suitable transformation methods, which are arranged in containers and called depending on the user data D10. For example, the user data D10 also comprises an information about which transformation method is desired, e.g., a post-processing or a re-training, or about requirements in terms of delivery time.

The trigger 202, in this embodiment the Lambda function, starts, for example, a data processing-Engine for containers, e.g., AWS Fargate, with a trigger call S32 and provides user data location. The AI model transformation then is performed in the backend 203, for example with a container-orchestration service such as AWS ECS, where the Fargate container is executed.

As a result of this transformation, the trustworthy AI model is generated with the method explained in detail in the various embodiments above.

The transformation of the AI model as a web service is enabled due to the characteristics of the transformation method, in particular the dependence on the generated generic samples, where only a validation data set is necessary as the input, and moreover the usage of a calibration optimization, which does not affect the architecture or structure of the AI model, so that a deployment of the trustworthy AI model on user side is guaranteed.

The trustworthy AI model, as well as corresponding process protocols, are saved as a transformation result D20 in the memory 201 and finally provided to the user 100. This occurs, for example, via an AWS S3 event that sends the transformation result D20 directly to the e-mail address of the authenticated user 100, which has been saved in the memory 201.

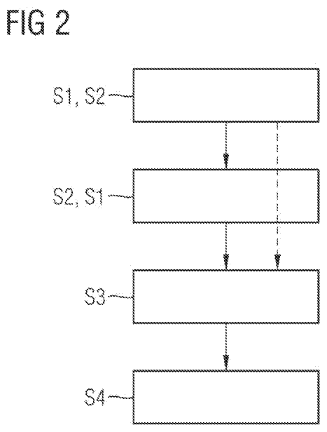

FIG. 2 shows a schematic flow chart diagram of a method, with the steps of providing S1 the trained artificial intelligence model via a user interface of a webservice platform, providing S2 a validation data set that is based on training data of the trained artificial intelligence model, generating S3 generic samples by a computing component of the webservice platform based on the validation data set, and transforming S4 the trained artificial intelligence model by optimizing a calibration based on the generic samples.

It is possible to perform steps S1 and S2 of providing the trained artificial intelligence model and the validation data set decoupled from each other and in a flexible order, as indicated by the exchangeable reference signs in FIG. 2. In other embodiments, they can be combined and performed within one method step or simultaneously, as indicated by the dotted arrow.

The step of transforming the trained artificial intelligence model is explained in more detail.

A cross entropy loss term is defined as

$${ℒ}_{j} = {\sum }_{j = 1}^{K} - {y}_{ij} log ( {p}_{ij} ) \qquad Eq . 1$$

and a uniform loss term as

$${ℒ}_{{uniform}_{i}} - {λ}_{t} {\sum }_{j = 1}^{K} - \frac{1}{K} log ( {p}_{ij} ( 1 - {y}_{ij} ) + {y}_{ij} ) \qquad Eq . 2$$

with p being the prediction, y a label, λₜ an annealing coefficient, t an index of a training step, i an index of a sample, j an index of a class and K the number of classes. This term encourages the model towards a uniformly distributed softmax output in case of uncertainty.

A calibration loss term is defined as

$${ℒ}_{{ECE}_{i}} = {‖ {ECC}_{{gen}_{i}} ‖}_{2}^{2} \qquad Eq . 3$$

$$ECE = {\sum }_{m = 1}^{M} \frac{\vert {B}_{m} \vert}{n} \vert acc ( {B}_{m} ) - conf ( {B}_{m} ) \vert \qquad Eq . 4$$

with ECC_{gen} being the ECE on the generic samples, with Bₘ being the set of indices of samples whose prediction confidence falls into its associated interval Iₘ. conf(Bₘ) and acc(Bₘ) are the average confidence and accuracy associated to Bₘ respectively, n the number of samples in the dataset, M a number of bins and m an index of bins. With this calibration loss term, which could be seen as generic calibration loss term, the technical robustness of the AI model for input around an epsilon-neighborhood of the training samples is increased.

These three loss terms are combined to retrain the AI model. As a result of the re-training, the trained AI model has been transformed into a trustworthy AI model, which yields confidence scores matching the accuracy for samples representing a domain shift, in particular gradually shifting away from samples of the validation data set.

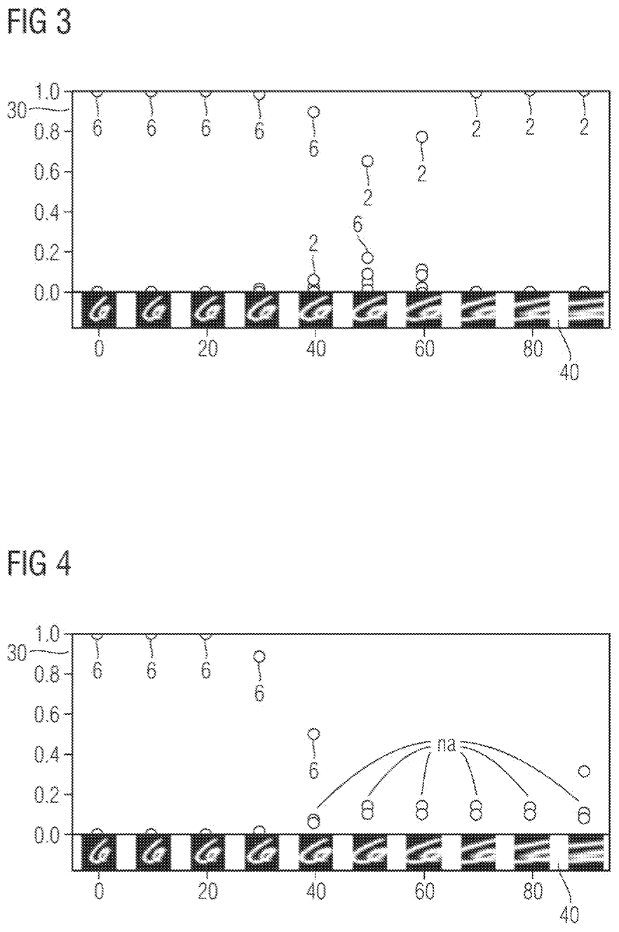

FIG. 3 illustrates a result of an AI model in accordance with the prior art, showing a schematic diagram of an output of a classifier. On the vertical axis 30 of the diagram, the confidence scores are shown, on the horizontal axis 40, the discrete input data is shown. From left to right, the quality of the input data, here in form of a handwritten figure “6”, decreased due to a distortion in one direction. Those kinds of distortions reflect effects on data input in real life scenarios, which impede accurate prediction of the classifier.

The classifier is trained to assign one of 10 classes to the input data, corresponding to FIGS. 0-9.

As evident, starting at about a range of perturbation of 50, which represents a flexible and arbitrary scale to group distortions and might be a value of epsilon, which has been introduced in the description above, the classifier starts to predict a wrong classification result, “2” in this case, but with a high confidence score over 60%, even increasing with increasing epsilon up to almost 100%. This illustrates an over-confident classifier when data with domain shift is to be classified.

In accordance with the third embodiment, which is illustrated in FIG. 4, the same classifier is used, but the underlying AI classification model has been transformed into a trustworthy AI model with the following method.

A set of samples are generated that cover the entire spectrum from in-domain samples to truly out-of-domain samples in a continuous and representative manner. According to this, the fast gradient sign method (FGSM) is used based on the validation data set with sample pairs to generate perturbated samples, with varying perturbation strength. More specifically, for each sample pair in the validation data set, the derivative of the loss is determined with respect to each input dimension and the sign of this gradient is recorded. If the gradient cannot be determined analytically (e.g. for decision trees), then it can be resorted to a 0th -order approximation and the gradient can be determined using finite differences. Noise $epsilon$ is then added to each input dimension in the direction of its gradient. For each sample pair, a noise level can be selected at random, such that the generic data set comprises representative samples from the entire spectrum of domain drift, as shown in the pseudo code of algorithm 1 and explanation.

```
  \begin{algorithm}[H]
    \caption{PORTAL with trained neural network $f(x)$, a
set of perturbation levels $\mathcal{E}=\{
0.001,0.002,0.004,0.008,0.016,0.032,0.064,0.128,0.256,0.512\}
$ , complexity parameter $\zeta=1$, validation set $(X, Y)$,
and empty perturbed validation set
$(X_\mathcal{E},Y_\mathcal{E}, Z_\mathcal{E},
Z\hat{ }r_\mathcal{E})$.
    }\label{alg1}
    \begin{algorithmic}[1]
    \For{(x, y) in (X,Y)}
        \For{$\epsilon\; \mathrm{in}\;\mathcal{E}$}
            \State Generate generic sample $x_\epsilon$
using $\epsilon_\zeta=\epsilon/\zeta$
            \State Use neural network $f(x_\epsilon)$ to
compute unnormalized logits $\bm{z_\epsilon}$ and logit range
$z_\epsilon\hat{ }r$
            \State Add $(x_\epsilon, y, \bm{z_\epsilon},
z_\epsilon\hat{ }r)$ to $(X_\mathcal{E},Y_\mathcal{E},
Z_\mathcal{E}, Z\hat{ }r_\mathcal{E})$
          \EndFor
      \EndFor
        \State Initialize $\bm{\theta}$
        \State Optimize $\bm{\theta}$ using Nelder-Mead
optimizer for log-likelihood of perturbed validation set
$\mathcal{L}(\bm{\theta}) = − \sum_{i=1}\hat{ }{N_\mathcal{E}} y_i
\log \hat{Q}_i(\bm{\theta}) = − \sum_{i=1}\hat{ }{N_\mathcal{E}}
y_i \log \sigma_{SM}(\mathbf{z}_i/T(z\hat{ }r_i;\bm{\theta}))$
    \end{algorithmic}
  \end{algorithm}
```

Algorithm 1 Generation of generic data set V_{g} based on validation V, consisting of a collection of labelled samples {(x, y)}, with x being model inputs an y model outputs. N denotes the number of samples in V, ε={0,0.05,0.1,0.15,0.2,0.025,0.3,0.35,0.4,0.45} the set of perturbation levels.

Require: Validation set V and empty generic data set V_{g}
1: for i in 1:N do
2: Read sample pair (xᵢ, yᵢ) from V
3: Randomly sample ϵᵢ from ε
4: Generate generic sample pair (_{g}, y) using the FGSM method based on ϵᵢ
5: Add (x_{g}, y) to V_{g}
6: end for
x_{g} denotes a generic input generated from x using the FGSM method.

In accordance with an alternative embodiment, the formulation of Algorithm 1 differs because not only one generic sample is generated per sample pair but, instead, FGSM is applied for all available epsilons. Thereby, the size of the generic data set can be significantly increased by the size of the set of epsilons. In other words, different perturbation strategies can be used, e.g., based on image perturbation. The advantage is that the method in accordance with the invention can be applied on black box models where it is not possible to compute the gradient.

Next, a strictly monotonic parameterized function is used to transform the unnormalized logits of the classifier. For example, Platt scaling, temperature scaling, other parameterizations of a monotonic function, or non-parametric alternatives can be used. In an embodiment, according to the following relationship a novel parameterization is used, which adds additional flexibility to known functions by introducing range-adaptive temperature scaling. While in classical temperature scaling a single temperature is used to transform logits across the entire spectrum of outputs, a range-specific temperature is used for different value ranges.

The following is a formula of a preferred embodiment:

$$T ( {z}^{r} ; θ ) = exp\_id ( \begin{matrix}{θ}_{1} \\ {( {z}^{r} + {θ}_{2} )}^{{θ}_{3}}\end{matrix} \vert {θ}_{0} ) \qquad Eq . 5$$

with θ=[θ₀, . . . θ₃] parameterizing the temperature T(z^{r}:θ) and zᵣ=max(z) min(z) being the range of an unnormalized logits tuple z.θ₀ can be interpreted as an asymptotic dependency on z^{r}. The following function an be used exp_id : x−>{x+1, x>0; exp(x), else} to ensure a positive output. This parameterized temperature is then used to obtain calibrated confidence scores \hat{Q}ₗ, for sample i based on unnormalized logits:

$${Q}_{i} = max {{θ}_{SM} ( {z}_{i} / T ( {z}_{i}^{r} ; θ ) )}^{( c )} \qquad Eq . 6$$

$$\int c , T : ℝ \to ℝ$$

$$\int c , T : x \to \{ \begin{matrix}\frac{x}{\vert {τ}_{1} \vert} & if x < {C}_{1} & \\ \frac{x - {C}_{h} - 1}{\vert T h \vert} + {\sum }_{i - 1}^{h - 1} \frac{{C}_{i} - {C}_{i - 1}}{\vert Ti \vert} & if {C}_{h - 1} \leq x < {C}_{h} , & h = 2 , … , H\end{matrix}$$

$$with H := dim ( T )$$

$${c}_{0} := 0 ,$$

$${c}_{H} := ∞$$

Sigma_SM denotes the softmax function. The parameters of the function (theta) are then determined by optimizing a calibration metric based on the generic data set. Calibration metrics can be the log likelihood, the Brier score or the expected calibration error, see also Algorithm 2.

Algorithm 2 Fit parameterized post-processing model u=∫(z, T), where ∫ is a strictly monotonic function parameterized by parameters T and maps the unnormalized logits z=C(x) of a classifier C to transformed (still unnormalized) logits u. Let g denote a calibration metric that is used to compute a scalar calibration measure w based on a set of logits along with ground truth labels.

Require: Generic set V_{g} (from algorithm 1), function ∫ with initial parameters T, calibration metric g.
1: repeat
2: Read sample pairs from,. Let be the set of all labels.
3: Compute post-processed logits u=∫(z, T), for all z=C(x_{adv}) comprising set U.
4: Perform optimization step and update T to optimize g(U, Y)
5: until Optimisation converged
6: return Optimized T

In an alternative embodiment of a blackbox classifier where logits are not available, Algorithm 2 can be adapted such that unnormalized logits are generated by computing z=log(C(x)). Optimizers can be advantageously selected in accordance with the form of the metric (e.g., Nelder Mead for piecewise temperature scaling) in a flexible manner.

After the trained AI classification model has been transformed with the method in accordance with the disclosed embodiments, the same input data as used in connection with the state of the art model from FIG. 3 is now used to be classified by the trustworthy AI classification model. As evident from FIG. 4, up to a perturbation level of 20, the right class “6” is predicted with the same high confidence as predicted with the prior art method. The confidence level decreases slightly from almost 100% to about 80% for a perturbation level of 30. For 40, there is already a confidence level for the predicted class of only around 50%, so that there is a clear indication that the prediction is subject to uncertainty. Up from epsilon 50, the trustworthy AI classifier gives a prediction rate of about 10% for essentially all classes na. This translates to a result “no classification possible with sufficient certainty”, so that all of the ten classes might be the correct prediction, leading to a confidence score of 1/10 or 10%.

The transformed trustworthy AI model can in an advantageous manner be used be a non-expert user in an application for AI-based classifying also in safety-critical applications, where a timely recognition of decreasing accuracy for prediction also for input data under domain drift is key and over-confident estimates must be avoided.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-18. (canceled)

19. A computer-implemented method for transforming a trained artificial intelligence model into a trustworthy artificial intelligence model, the method comprising:
providing the trained artificial intelligence model via a user interface of a webservice platform;
providing a validation data set which is based on training data of the trained artificial intelligence model;
generating generic samples by a computing component of the webservice platform based on the validation data set, the validation data set being modified by a domain-drift to generate the generic samples; and
transforming the trained artificial intelligence model by optimizing a calibration based on the generic samples.

20. The method according to claim 19, wherein by optimizing the calibration, an uncertainty-awareness is represented in a confidence-level for any of the generic samples.

21. The method according to claim 19, wherein the validation data set is modified according to perturbation strengths to generate the generic samples.

22. The method according to claim 19, wherein said transforming comprises performing a re-training of the artificial intelligence model with applying an entropy-based loss term which encourages uncertainty-awareness.

23. The method according to claim 22, wherein said transforming further comprises applying a calibration loss term.

24. The method according to claim 22, further comprising:
generating current outputs of the artificial intelligence model for the validation data set by forward propagating validation input data of the validation data set in the artificial intelligence model;
computing a categorical cross-entropy loss L_{CCE} for the validation data set based on the current outputs and corresponding ground truth data of the validation data set;
computing a predictive entropy loss Ls by removing non-misleading evidence from the current outputs and distributing the remaining current outputs over a predetermined number C of classes;
computing a combined loss L by adding to a categorical cross-entropy loss L_{CCE} a predictive entropy loss L_{S} weighted with a predetermined first loss factor λ_{S}, where 0<=λ_{S}<=1;
checking whether the re-training converged to a predefined lower limit for a convergence rate;
updating weights of the artificial intelligence model based on the combined loss L and a predetermined training rate η, where 0<η<=1, in case the re-training did not converge; and
stopping the re-training of the artificial intelligence model in case the re-training converged.

25. The method according to claim 23, further comprising:
generating current outputs of the artificial intelligence model for the validation data set by forward propagating validation input data of the validation data set in the artificial intelligence model;
computing a categorical cross-entropy loss L_{CCE} for the validation data set based on the current outputs and corresponding ground truth data of the validation data set;
computing a predictive entropy loss L_{S} by removing non-misleading evidence from the current outputs and distributing the remaining current outputs over a predetermined number C of classes;
computing a combined loss L by adding to a categorical cross-entropy loss L_{CCE} a predictive entropy loss L_{S} weighted with a predetermined first loss factor λ_{S}, where 0<=λ_{S}<=1;
checking whether the re-training converged to a predefined lower limit for a convergence rate;
updating weights of the artificial intelligence model based on the combined loss L and a predetermined training rate η, where 0<η<=1, in case the re-training did not converge; and
stopping the re-training of the artificial intelligence model in case the re-training converged.

26. The method according to claim 24, further comprising:
generating perturbed outputs of the artificial intelligence model for the generic samples by forward propagating generic input data X_{adv} of the generic samples in the artificial intelligence model;
computing a calibration loss L_{adv} as an Euclidian norm (L₂ norm) of an expected calibration error ECE, which takes a weighted average over the perturbed outputs grouped in a predefined number M of equally spaced bins each having an associated average confidence and accuracy, where M>1;
checking whether the re-training converged to a predefined lower limit for a convergence rate;
first time updating weights of the artificial intelligence model based on the combined loss L and a predetermined training rate η, where 0<η<=1, in case the training did not converge;
second time updating the weights of the artificial intelligence model based on the calibration loss L_{adv} weighted with a predetermined second loss factor λ_{adv}, where 0<=λ_{adv}<=1, and the predetermined training rate η, in case the training did not converge; and
stopping the training of the artificial intelligence model in case the training converged.

27. The method according to one of claim 22, wherein the artificial intelligence model is a neural network.

28. The method according to one of claim 23, wherein the artificial intelligence model is a neural network.

29. The method according to one of claim 24, wherein the artificial intelligence model is a neural network.

30. The method according to claim 19, wherein said transforming comprises post-processing an output of the artificial intelligence model.

31. The method according to claim 20, wherein said transforming comprises post-processing an output of the artificial intelligence model.

32. The method according to claim 21, wherein said transforming comprises post-processing an output of the artificial intelligence model.

33. The method according to claim 30, wherein during said step of post-processing, parameters of a monotonic function used to transform unnormalized logits are determined by optimizing a calibration metric based on the generic samples.

34. The method according to claim 30, wherein the artificial intelligence model is a classifier comprising one of a deep neural network, gradient boosted decision tree, xgboost, support vector machine, random forest and neural network.

35. The method according to claim 33, wherein the artificial intelligence model is a classifier comprising one of a deep neural network, gradient boosted decision tree, xgboost, support vector machine, random forest and neural network.

36. The method according to claim 19, wherein the validation data set is a sub-set of the training data of the trained artificial intelligence model.

37. The method according to claim 19, wherein the validation data set is generated by modifying the training data of the trained artificial intelligence model.

38. The method according to claim 19, wherein the transformed artificial intelligence model is provided via the user interface of the webservice platform as a downloadable file.

39. A non-transitory computer program product encoded with program instructions which, when executed by a computing component, cause the computing component to transform a trained artificial intelligence model into a trustworthy artificial intelligence model, the program instructions comprising:
computer code for providing the trained artificial intelligence model via a user interface of a webservice platform;
computer code for providing a validation data set which is based on training data of the trained artificial intelligence model;
computer code for generating generic samples by a computing component of the webservice platform based on the validation data set, the validation data set being modified by a domain-drift to generate the generic samples; and
computer code for transforming the trained artificial intelligence model by optimizing a calibration based on the generic samples.

40. A system for transforming a trained artificial intelligence model into a trustworthy artificial intelligence model, comprising:
a user interface component to enable provision of the trained artificial intelligence model;
a memory storing the trained artificial intelligence model and user assignment information;
a computing component for generating generic samples based on a validation data set determined based on training data of the trained artificial intelligence model and for transforming the trained artificial intelligence model by optimizing a calibration based on the generic samples, the validation data set being modified by a domain-drift to generate the generic samples.

41. The system according to claim 40, wherein the user interface component is accessible via a webservice.

42. The system according to claims 40, wherein the memory and the computing component are implemented on a cloud platform.

43. The system according to claims 41, wherein the memory and the computing component are implemented on a cloud platform.
